(19) United States
(12) Patent Application Publication
(10) Pub. No.: US 2009/0037506 A1
(43) Pub. Date: Feb. 5, 2009

(54) RECEIVING APPARATUS AND METHOD

(75) Inventor: Takashi Mochizuki, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC, Minato-ku, Tokyo (JP)

(21) Appl. No.: 11/817,182

(22) PCT Filed: Feb. 7, 2006
(86) PCT No.: PCT/JP2006/302071

§ 371 Date: Aug. 27, 2007

(30) Foreign Application Priority Data
Mar. 9, 2005 (JP) 2005-064951
Oct. 12, 2005 (JP) 2005-297603

(51) Int. Cl. G06F 17/14

(52) U.S. Cl. 708/404

(57) ABSTRACT

A FFT circuit performs M×R×Q-point fast Fourier transform of received signals, wherein M is an over-sampling rate of the received signals, Q is a chip repetition unit and R is a chip repetition rate. A weighting multiplier multiplies a frequency component having frequency component number equal to an integral multiple of R among M×R×Q frequency components output from the fast Fourier transform circuit by a weighting coefficient for propagation channel equalization, and multiplies the frequency components other than the integral multiple of R. An inverse fast Fourier transform circuit receives outputs of weighting multiplier and performs inverse fast Fourier transform of the frequency component having a frequency number equal to the integral multiple of R.

### FIELD OF THE INVENTION

The present invention relates to receiving apparatus and method and, more particularly, to receiving apparatus and method for receiving, via frequency domain equalization, a signal transmitted using a chip repetition technique in a transmission system for transmission/reception using a code division multiple access (CDMA) system.

### BACKGROUND ART

In recent years, the CDMA system attracts a significant attention as a communication system. The techniques relating to communication in the CDMA system include one described in, for example, Patent Publication JP-2004-297756A. In this technique, the transmitting side repetitively transmits, for a specific number of times, a specific number of chips as a set for the chip sequence after spreading of the chips. This situation is shown in FIG. 7. In this example, the chip sequence after the spreading is repeated for R times for every Q chips. The receiving side synthesizes the repeated chip sequence to restore the chip sequence after the spreading, and de-spreads the restored chip sequence to demodulate the original signal. It is described in the patent publication that a plurality of patterns are prepared for the repetition of the chips for the control. It is also described therein that the chip sequence to be repeated is subjected to different phase rotations for different transmitted sequences and is transmitted, whereby an orthogonal nature is applied between the transmitted sequences. In this case of transmission after the phase rotations, the receiving side synthesizes the chips after removing the phase rotations.

The receiving techniques in the communication system using the chip repetition include one using the frequency domain equalization such as described in a literature entitled “Institute of Electronics, Information and Communication Engineers technical research report Vol. 104 No. 399”, Yoshikazu GOTO, Teruo KAWAMURA, Hiroyuki ATARASHI, and Mamoru SAWAHASHI, Oct. 22, 2004 issue, pp. 135-140 (RCS2004-197). FIG. 8 shows the configuration of the receiving apparatus described in this literature. The phase rotation for every transmitted sequence in the received baseband signal is removed by a phase rotation removal unit 80, and synthesized for chip repetitions by a chip repetition synthesis unit 81. The output of the chip repetition synthesis unit 81 is subsequently decomposed into frequency components in a FFT circuit 82 by performing M×Q-point fast Fourier transform. Here, Q is the unit of chip repetitions and M is the over-sampling rate of the received signals.

The received signals subjected to the fast Fourier transform in the FFT circuit 82 are multiplied by a weighting coefficient, which is provided from a control circuit 86 for every coefficient, for each frequency component in a weighting multiplier 83, and thereafter is subjected to an inverse fast Fourier transform in an IFFT circuit 82 to return to the time series signal. De-spreading is then performed finally in a de-spreading circuit 85, to restore the signal before the spreading. In the above non-patent literature 1, “1” and “4” are exemplified as the chip repetition rate R. As to the chip repetition unit Q, it is recited that Q=2048 in the case of R=1, and Q=512 in the case of R=4. It is also recited that the over-sampling rate M is “1”. Therefore, M×R×Q is a constant of “2048”.

FIG. 9 shows the configuration of the phase rotation removal unit 80. A complex multiplier 60 inputs a received baseband signal, and performs multiplication of the received baseband signal by a complex number corresponding to the phase k of each transmitted sequence (k: 0 to R−1) and the sampling number “i” (0 to (M×R×Q-1)) of the received baseband signal. More specifically, the phase rotation removal unit 80 multiplies the received baseband signal by

$${e}^{( j \frac{2 π k i}{M \cdot R \cdot Q} )} ,$$

to thereby remove the phase rotation.

FIG. 10 shows the configuration of the chip repetition synthesis unit 81. A memory 88 is a rewritable memory and stores therein M×Q chip signals. In the circuit shown in the same figure, an input signal is added for R times for each M×Q chip by the loop configured by the memory 88 and an adder 87. A control circuit 89 supplies a read/write address to the memory 88, and instructs clearance of the contents of the memory. The control circuit 89 changes the address signal and clear signal depending on the M×Q and chip repetition number R, as shown in FIG. 11, and allows the memory 88 to store the chip signals in the number of M×Q chips. The storage capacity of the memory 88 is designed corresponding to the maximum of the chip repetition unit Q.

FIG. 12 shows the configuration of the FFT circuit. The FFT circuit 82 should have a size corresponding to the maximum of the chip repetition unit Q as the hardware device, if the Q is variable. In the fast Fourier transform, processing of a size corresponding to the reciprocal of a power-of-two can be achieved as a partial processing. For example, if the fast Fourier transform of N/2 points is to be performed by using an N-point FFT as shown in FIG. 12, it is sufficient to use 0-th to ((N/2)−1)-th inputs therein as shown in FIG. 13; and if the fast Fourier transform of N/4 points is to be performed by using the same FFT, it is sufficient to use 0-th to ((N/4)−1)-th inputs therein as shown in FIG. 14. Here, the sequential number of the output signals corresponds to the inversed sequential order of the bits which represent log₂(N) of the sequential number of the input signals. For example, if N=16, then the input signal of the first order (0001) corresponds to a (N/2)-th output (1000).

FIG. 15 shows the example of a configuration of the coefficient-weighting multiplier. The coefficient-weighting multiplier 83 includes N input terminals corresponding to the outputs of the FFT circuit 82. The coefficient-weighting multiplier 83 multiplies each of the N input signals in a multiplier 94 by a weighting coefficient supplied from the control circuit 86, to deliver the same to the IFFT circuit 84. The IFFT circuit 84 should have a size corresponding to the maximum of the chip repetition unit Q as a hardware device, similarly to the FFT circuit 82. As to the inverse fast Fourier transform, processing of a size corresponding to the reciprocal of the power-of-two can be achieved by a partial processing of an inverse fast Fourier transform of N points, similarly to the fast Fourier transform, and may be achieved by a configuration wherein the inputs and the outputs in FIG. 13 are reversed.

### DISCLOSURE OF THE INVENTION

### Problems to be Solved by the Invention

There are following problems in the technique described in the above non-patent literature 1.

The first problem is that the circuit scale thereof is large because the chip repetition synthesis unit 81 requires a memory size corresponding to the maximum of the Q. The second problem is that the operation of the chip repetition synthesis unit 81, FFT circuit 82, and IFFT circuit 84 should be controlled depending on the chip repetition rate Q if the Q is variable, to thereby complicate the control circuit. For example, if the chip repetition unit Q is changed, it is necessary to prepare the pattern of the control signals shown in FIG. 11 corresponding to each of the variable patterns of Q, because the maximum address of the read/write addresses of the internal memory is changed in the chip repetition synthesis unit 81. In addition, the FFT circuit 82 requires a switch for changing the input signals to a partial processing, upon performing a smaller size processing.

The third problem is that the processing time length changes depending on the chip repetition unit Q, if a part of the FFT circuit is used for the processing depending on the chip repetition rate Q. For example, if the chip repetition unit Q is smaller, the processing time of the FFT circuit 82 or IFFT circuit 84 is shorter, whereby the time interval between the input of the signals to the chip repetition synthesis unit 81 and the output of the de-spread signals from the de-spreading circuit 85 considerably changes depending on the chip repetition unit Q. For this reason, a delay circuit for absorbing the change of the processing time length may be necessary depending on the circuit configuration to match the processing timing.

It is an object of the present invention to solve the problems in the above conventional technique and provide a receiving apparatus and a method capable of reducing the circuit scale in the receiving apparatus and method for demodulating transmitted signals, which are subjected to chip repetition, by using frequency domain equalization. It is another object to provide receiving apparatus and method which do not require a complicated control even if the ratio of the R to the Q is changed.

### Means for Solving the Problems

The present invention provides a receiving apparatus of a code division multiple access system using a chip repetition scheme repetitively transmitting a spreading chip sequence for R times (R: power-of-two) with Q chips as a set (Q: power-of-two), the receiving apparatus including: a fast Fourier transform circuit performing M×R×Q-point fast Fourier transform of received signals to decompose the received signals into complex amplitudes of M×R×Q frequency components and output the same, where M (power-of-two) is an over-sampling rate of the received signals; a weighting multiplication circuit multiplying, by a weighting coefficient for propagataion channel equalization, a frequency component having a frequency component number equal to an integral multiple of R among the M×R×Q frequency components obtained by the fast Fourier transform circuit; and an inverse fast Fourier transform circuit performing inverse fast Fourier transform using a frequency component output from said weighting multiplier and having the frequency component number equal to the integral multiple of R.

The present invention also provides a receiving method of a code division multiple access system using a chip repetition scheme repetitively transmitting a spreading chip sequence for R times (R: power-of-two) with Q chips as a set (Q: power-of-two), the method including: performing M×R×Q-point fast Fourier transform of received signals to decompose the received signals into complex amplitudes of M×R×Q frequency components and outputting the same, where M (power-of-two) is an over-sampling rate of the received signals; multiplying, by a weighting coefficient for propagataion channel equalization, a frequency component having a frequency component number equal to an integral multiple of R among the M×R×Q frequency components obtained by the fast Fourier transform; and performing inverse fast Fourier transform using the frequency component multiplied by the weighting coefficient and having the frequency component number equal to the integral multiple of R.

In the receiving apparatus and receiving method of the present invention, the M×R×Q-point fast Fourier transform is performed to the received signals transmitted using a chip repetition scheme, without performing synthesis of chip repetitions, and the inverse fast Fourier transform is performed after multiplication of the frequency component having a frequency component number equal to an integral multiple of R by the weighting coefficient for propagataion channel equalization. The frequency components having the integral multiple of R among the frequency components obtained by the fast Fourier transform are identical to the frequency components obtained by M×Q-point fast Fourier transform of the signals obtained by R-set synthesis of M×Q signals, due to the nature of the fast Fourier transform. For this reason, according to the receiving apparatus and method of the present invention, R-set synthesized signals of M×Q signals can be obtained even without providing a circuit for synthesizing the chip repetitions, whereby the circuit scale can be reduced. In addition, the contents of processing of the fast Fourier transform and inverse fast Fourier transform are constant, even if the ratio of the chip repetition rate R to the chip repetition unit Q is changed, whereby these transform processings need not be controlled depending on the parameters, thereby preventing a complicated control.

The receiving apparatus of the present invention may employ a configuration further including a frequency component shift circuit shifting M×R×Q frequency components output from the fast Fourier transform circuit by a specified component number, to input the same to the weighting multiplier. In this case, a configuration may be employed wherein the frequency component shift circuit delivers to the weighting multiplier a frequency component having a frequency component number equal to the integral multiple of R minus k as a frequency component having a frequency component number equal to the integral multiple of R. The receiving method of the present invention may employ a configuration wherein the multiplying of the weighting coefficient shifts M×R×Q frequency components output from the fast Fourier transform by a specified component number, and multiplies the shifted frequency component having the frequency component number equal to the integral multiple of R by the weighting coefficient. In this case, a configuration may also be employed wherein the shifting of the frequency component shifts the frequency components so that a frequency component number equal to the integral multiple of R minus k shifts to the frequency component number equal to the integral multiple of R. In the case where a phase rotation is performed in the transmitting side, if the fast Fourier transform is performed without removing the phase shift, the frequency components having a frequency component number equal to the integral multiple of R minus k among the frequency components obtained by the fast Fourier transform are identical to the output frequency components obtained by M×Q-point fast Fourier transform of R-set synthesized signals after the phase rotation removal of phase k from the M×Q signals, due to the nature of the fast Fourier transform. Therefore, by shifting the frequency component numbers by an amount corresponding to the phase k before multiplication by the weighting coefficient, R-set synthesized signals of the M×Q point signals can be obtained without performing the phase rotation removal before the fast Fourier transform, whereby the circuit scale of the receiving apparatus can be reduced.

The receiving apparatus and method of the present invention may employ a configuration wherein the multiplying by the weighting coefficient multiples a frequency component having a frequency component number other than the integral multiple of R among M×R×Q frequency components by a weighting coefficient of zero. In this case, if the phase rotation is performed in the transmitting side, it is sufficient that the frequency components be shifted by a specified number and the weighting coefficient for the shifted frequency components having a frequency component number other than the integral multiple of R be set zero. The receiving apparatus and method of the present invention may employ a configuration wherein the fast Fourier transform nulls an output of frequency component having a frequency component number other than the integral multiple of R among M×R×Q frequency components. In these cases, the frequency components unnecessary for the inverse fast Fourier transform can be made zero. In addition, in the configuration wherein the weighting coefficient other than the integral multiple of R is set zero, it is unnecessary to control the fast Fourier transform depending on the Q even if the ratio of R to Q is changed, thereby providing an advantage of simple control.

It is preferable in the receiving apparatus and method of the present invention that the inverse fast Fourier transform performs M×R×Q-point inverse fast Fourier transform. In this case, if the ratio of Q to R is changed, the inverse fast Fourier transform need not be controlled depending on the Q, which does not complicate the control. In addition, since the processing time length needed for the fast Fourier transform and inverse fast Fourier transform can be fixed, it is unnecessary to use a delay circuit etc. for adjusting the timing.

### EFFECTS OF THE INVENTION

In the receiving apparatus and method of the present invention, M×R×Q-point fast Fourier transform is performed to the received signals transmitted using the chip repetition scheme, and the frequency components having an integral multiple of R among them are subjected to multiplication by a weighting coefficient for propagataion channel equalization and inverse fast Fourier transform. In this way, M×Q point signals can be synthesized for R sets, and the inverse fast Fourier transform can be performed to the same signals to which the M×Q-point fast Fourier transform is performed, without providing a circuit for synthesizing the chip repetitions, whereby reduction in the circuit scale is obtained. In addition, if phase rotation is performed in the transmitting side, the frequency components obtained by the fast Fourier transform are shifted depending on the phase and are subjected to weighting multiplication, whereby the inverse fast Fourier transform can be performed to the signals identical the signals, which are obtained by M×Q-point fast Fourier transform of R-set synthesis of M×Q signals performed after removing the phase rotation, without providing a circuit for removing the phase rotation, thereby reducing the circuit scale of the receiving apparatus. If the M×R×Q-point inverse fast Fourier transform is to be performed irrespective of the ratio of Q to R, the control is not complicated if the ratio of Q to R is changed, to obtain a constant processing time length needed for the processings.

### BEST MODE FOR CARRYING OUT THE INVENTION

Hereinafter, embodiments of the present invention will be described in detail with reference to the drawings. FIG. 1 shows the configuration of a receiving apparatus according to a first embodiment of the present invention. The receiving apparatus 10 includes a FFT circuit 11, a weighting multiplier 12, an IFFT circuit 13, and a control circuit 14. The receiving apparatus 10 is configured, similarly to the conventional receiving apparatus shown in FIG. 8, as a receiving apparatus which receives, via a frequency domain equalization, the signals transmitted by the code division multiple access (CDMA) system using a chip repetition scheme. FIG. 2 shows the received signals in a timing chart. The receiving apparatus 10 receives M×Q chip signals for each set for R times, wherein M (M is a power-of-two) is the over-sampling rate, R (R is a power-of-two) is the number of chip repetitions, and Q (Q is a power-of-two) is the chip repetition unit.

The FFT circuit 11 performs M×R×Q-point fast Fourier transform of to the input signals. The weighting multiplier 12 multiplies the output signals of the FFT circuit 11 by a weighting coefficient supplied from the control circuit 14 according to the instruction by the control circuit 14, to output the same. The IFFT circuit 13 receives the output signals of the weighting multiplier 12 to perform thereon M×R×Q-point inverse fast Fourier transform. The FFT circuit 11 and IFFT circuit 13 may be fast Fourier transform circuit and inverse fast Fourier transform circuit, respectively, generally used in the art. The multiplier shown in FIG. 15 may be used as the weighting multiplier 12.

The FFT circuit 11 may have separate units as shown in FIG. 3, for example. In this example, the FFT circuit 11 performs fast Fourier transform of N (=M×R×Q) points, and includes a first adder 21, a circuit-A 22, and a N/2-point FFT circuit 23. The circuit-A 22 is configured as a circuit which obtains the complex amplitude of the odd-numbered frequency components of the N-point FFT, and obtains the complex amplitude of N/2 odd-numbered frequency components having a frequency component number in the range of 1 to (N−1) among the N input signals. The first adder 21 adds together two input signals apart from one another by N/2 samples, and outputs the sum to the N/2-point FFT circuit 23.

The N/2-point FFT circuit 23 includes a second adder 24, a circuit-B 25, and a N/4-point FFT circuit 26. The N/2-point FFT circuit 23 receives the output signal of the first adder 21, and performs N/2-point fast Fourier transform processing. The circuit-B 25 is configured as a circuit which obtains the complex amplitude of the odd numbered frequency components of the N/2-point FFT, and obtains the complex amplitude of N/4 frequency components having a specific frequency component number which is a multiple of four plus two and resides in the range of 2 to (N−2). The second adder 24 adds together output signals of two adders 21 which are apart from one another by N/4 samples, to output the sum to the N/4-point FFT circuit 26. The N/4-point FFT circuit 26 receives the outputs of the second adders 24, and delivers N/4 output signals having a specific frequency component number which is a multiple of four and resides in the range of zero to N/4.

It is assumed here that M=1, Q=8, and R=2 (N=16). The signals input to the FFT circuit 11 in this case are shown in FIG. 4. The signals #0 to #7 of the first set in the chip repetitions are input through input terminals the #0 to #7, respectively, of the FFT circuit 11, the signals #0 to #7 of the second set are input through the input terminals #8 to #15, respectively, of the FFT circuit 11. In the FFT circuit 11, the signals obtained by adding the signals #0 to #7 of the first set to the signals #0 to #7, respectively, of the second set in the adder 21, are input to the N/2-point FFT circuit 23. Thus, the input signals of N/2-point FFT circuit 23 are signals obtained by the chip repetition synthesis using a chip repetition unit Q of 8 (N/2) and a chip repetition rate R of 2, similarly to the output signals of the chip repetition synthesis unit 81 in FIG. 8. For this reason, if Q=N/2 and R=2, the output signals of N/2-point FFT circuit 23 are identical to the output signals of the FFT circuit 82 in the conventional receiving apparatus shown in FIG. 8.

If M=1, Q=4 and R=4 (N=16), as shown in FIG. 5, signals #0 to #3 of the first set are input through the input terminals #0 to #3 of the FFT circuit 11, and signals #0 to #3 of the second set are input through the input terminals #4 to #7 of the FFT circuit 11. In addition, signals #0 to #3 of the third set are input through the input terminals #8 to #11 of the FFT circuit 11, and the signals #0 to #3 of the fourth set are input through the input terminals #12 to #15 of the FFT circuit 11. In the FFT circuit 11, signals of the first set are added to the signals of the third set, and the signals of the second set are added to the signals of the fourth set in the first adder 21, whereas the sum of the first set and the third set is added to the sum of the second set and fourth set in the second adder 24, whereby the summed signals are input to the N/4-point FFT circuit 26. Thus, the input signals of the N/4-point FFT circuit 26 are identical to the signals that the chip repetition synthesis unit 81 in FIG. 8 outputs, and the output signals of the N/4-point FFT circuit 26 are identical to the output signals of the FFT circuit 82 in the conventional receiving apparatus shown in FIG. 8.

As described above, if the received signals are subjected to the N-point (M×R×Q points) fast Fourier transform, a frequency component having a frequency component number equal to an integral multiple of R is identical to the signal which is obtained by the M×Q-point fast Fourier transform of the R-set synthesized signal with the M×Q chips as a set, due to the nature of the fast Fourier transform. The control circuit 14 sets the weighting coefficient of the weighting multiplier 12 at the weighting coefficient of the propagataion channel equalization for the frequency components having a frequency component number equal to an integral multiple of R corresponding to the outputs of the M×Q fast Fourier transform, and sets the weighting coefficient at zero for the other frequency components. As a consequence, the weighting multiplier 12 performs multiplication of the frequency components having a frequency component number of the integral multiple of R by the weighting coefficient for the propagataion channel equalization, allows the other frequency components to assume zero, and outputs the resultant frequency components.

As the result of multiplication by the weighting coefficient in the weighting multiplier 12, the signals obtained by synthesizing the R sets with the M×Q chips as a set are input through the input terminals of the IFFT circuit 13 having frequency numbers corresponding to integral multiples of R, and zero is input through the input terminals for the frequency component numbers other than the integral multiple of R. Since the complex amplitude of the frequency components input to the IFFT 13 and rendered unnecessary by the chip repetition synthesis assumes zero, it is sufficient for the IFFT circuit 13 to perform M×R×Q-point inverse fast Fourier transform regardless of the change of the ratio of the chip repetition rate R to the chip repetition unit Q, even if the ratio is changed. The output signals of the IFFT circuit 13 are such that the M×Q-point signals are repeated for R times, and the M×Q-point signals are identical to the output signals of the IFFT circuit 84 in the conventional receiving apparatus shown in FIG. 8. Therefore, it is sufficient to de-spread the top M×Q points, for example, similarly to the conventional receiving apparatus.

According to the present embodiment, fast Fourier transform of the input signals is performed in the FFT circuit 11, without synthesis of the chip repetitions. Since the chip repetition synthesis processing is performed using a part of the circuit prepared for processing of the maximum size in the FFT circuit 11, M×Q-point fast Fourier transform can be achieved after synthesizing the R sets with the M×Q chips as a set even if the chip repetition synthesis unit is not provided separately. Thus, the circuit area can be reduced because the chip repetition synthesis unit is unnecessary. In the chip repetition synthesis processing, the address assignment for the memory (FIG. 10) should be controlled depending on the Q and R, thereby complicating the control. According to the present embodiment, if the Q and R are changed, only the weighting coefficient of the weighting multiplier 12 is to be changed, which does not complicate the control.

According to the present embodiment, if the product of the chip repetition rate R and chip repetition unit Q is constant, the processing size of the fast Fourier transform and inverse fast Fourier transform performed by the FFT circuit 11 and IFFT circuit 13, respectively, is a fixed size. Therefore, even if the ratio of the chip repetition rate R to the chip repetition unit Q is changed, the contents of processing by the FFT circuit 11 and IFFT circuit 13 are constant, and it is unnecessary to control the FFT circuit 11 and IFFT circuit 13 depending on these parameters, which does not complicate the control. Since the processing time length of the FFT circuit 11 and IFFT circuit 13 is constant, it is unnecessary to provide a delay element etc. for adjusting the processing timing even if the ratio of the chip repetition rate R to the chip repetition unit Q is changed.

In the above embodiment, the frequency components having a frequency component number of the input of the IFFT circuit 13 other than the integral multiple of R are set to zero by using the weighting multiplier 12. In an alternative, the FFT circuit 11 may set zero for the outputs of the circuits for generating the frequency components having a frequency component number other than the integral multiple of R. For example, it is sufficient to null the outputs of the circuit-A 22 in FIG. 4. In an alternative of the weighting multiplier 12 setting zero for the frequency components having a frequency component number of the integral multiple of R input to the FFT circuit 13, the IFFT circuit 13 may perform M×Q-point inverse fast Fourier transform using only the frequency components having a frequency component number equal to the integral multiple of R. Also in this case, the time series signal can be obtained wherein the R sets are synthesized with the M×Q chips as a set in the M×Q-point inverse fast Fourier transform.

FIG. 6 shows the configuration of a receiving apparatus according to a second embodiment of the present invention. The receiving apparatus 10a of the present embodiment is different from the receiving apparatus of the first embodiment shown in FIG. 1 in that a frequency component shift circuit 15 is added between the FFT circuit 11 and the weighting multiplier 12. The frequency component shift circuit 15 outputs the complex amplitude of each frequency component output from the FFT circuit 11 while shifting by a predetermined number corresponding to the phase rotation. For example, if the phase rotation by phase k is applied on the transmitting side, the frequency component shift circuit 15 outputs the frequency components while shifting the frequency components by k based on the instruction from the control circuit 14. That is, in the case of the phase rotation used in the non-patent literature 1, the frequency component having an i-th frequency component number is output as an (i+k)-th frequency component. The frequency component shift circuit 15 may be configured by a 2-port memory having separate input port and output port, and may receive a #n block output signals of the FFT circuit and read the #n−1 block FFT output signals while shifting the frequency component number by k.

Hereinafter, the fast Fourier transform (discrete Fourier transform) will be described. In the discrete Fourier transform, a m-th frequency component output X (m) may be expressed, with an input as x(n), by the following equation:

$$X ( m ) = {\sum }_{n = 0}^{N - 1} x ( n ) {W}^{mn} \\ where \\ W = {e}^{- j \frac{2 π}{N}} . \qquad ( 1 )$$

Expression of this equation in a matrix results in:

$$( \begin{matrix}X ( 0 ) \\ X ( 1 ) \\ X ( 2 ) \\ ⋮ \\ X ( N - 1 )\end{matrix} ) = ( \begin{matrix}{W}^{0} & {W}^{0} & {W}^{0} & … & {W}^{0} \\ {W}^{0} & {W}^{1} & {W}^{2} & … & {W}^{N - 1} \\ {W}^{0} & {W}^{2} & {W}^{4} & … & {W}^{2 ( N - 1 )} \\ ⋮ & ⋮ & ⋮ & ⋱ & ⋮ \\ {W}^{0} & {W}^{N - 1} & {W}^{2 ( N - 1 )} & … & {W}^{{( N - 1 )}^{2}}\end{matrix} ) ( \begin{matrix}x ( 0 ) \\ x ( 1 ) \\ x ( 2 ) \\ ⋮ \\ x ( N - 1 )\end{matrix} ) . \qquad ( 2 )$$

If the transmitting side executes phase rotation by k, the received baseband signal x (n) is expressed by, with x′(n) as the received baseband signal upon removing the phase rotation:

$$x ( n ) = {x}^{′} ( n ) {e}^{- j \frac{2 π kn}{N}} . \qquad ( 3 )$$

Substituting this equation for equation (1) results in:

$$\begin{matrix}X ( m ) = {\sum }_{n = 0}^{N - 1} [ ( {x}^{′} ( n ) {e}^{- j \frac{2 π kn}{N}} ) {W}^{mn} ] \\ = {\sum }_{n = 0}^{N - 1} {x}^{′} ( n ) {W}^{mn + kn} \\ = {\sum }_{n = 0}^{N - 1} {x}^{′} ( n ) {W}^{n ( m + k )}\end{matrix} \qquad ( 4 )$$

From this equation (4), it will be understood that the frequency number m in the case of Fourier transform without removing the phase rotation is identical to the frequency number (m+k) which is obtained in the case of Fourier transform while removing the phase rotation.

Since the FFT circuit 11 performs the M×R×Q-point fast Fourier transform, the output of the frequency number m (m: 0 to M×R×Q−1) is expressed by:

$$X ( m ) = {\sum }_{n = 0}^{MQR - 1} x ( n ) {W}_{MRQ}^{mn} \\ where \\ {W}_{MRQ} = {e}^{- j \frac{2 π}{MRQ}} . \qquad ( 5 )$$

Among the outputs of the FFT circuit 11, the output of the frequency component having a frequency number equal to a sum of an integral multiple of R and a phase k is expressed by:

$$X ( Rm + k ) = {\sum }_{n = 0}^{MQR - 1} x ( n ) {W}_{MRQ}^{( Rm + k ) n} . \qquad ( 6 )$$

Transformation of this equation results in:

$$\begin{matrix}X ( Rm + k ) = {\sum }_{n = 0}^{MRQ - 1} x ( n ) {W}_{MRQ}^{( Rm + k ) n} \\ = {\sum }_{n = 0}^{MQ - 1} \{ {\sum }_{r = 0}^{R - 1} x ( n + rMQ ) {W}_{MRQ}^{( Rm + k ) ( n + rMQ )} \} \\ = {\sum }_{n = 0}^{MQ - 1} \{ {\sum }_{r = 0}^{R - 1} x ( n + rMQ ) {W}_{MRQ}^{k ( n + rMQ ) + rmMRQ} \} {W}_{MRQ}^{Rmn} .\end{matrix} \qquad ( 7 )$$

Here, the following relationship:

$${W}_{MRQ}^{rmMRQ} = {e}^{- j \frac{2 π}{MRQ} \cdot rmMRQ} = {e}^{- j2π rm} = 1$$

$${W}_{MRQ}^{Rmn} = {e}^{- j \frac{2 π}{MRQ} Rmn} = {e}^{- j \frac{2 π}{MQ} mn}$$

holds, and it is assumed that the following formula:

$${W}_{MQ} = {e}^{- j \frac{2 π}{MQ}}$$

holds. Then, the equation (7) may be expressed by:

$${\sum }_{n = 0}^{MQ - 1} \{ {\sum }_{r = 0}^{R - 1} x ( n + rMQ ) {W}_{MRQ}^{k ( n + rMQ ) + rmMRQ} \} {W}_{MRQ}^{Rmn} = {\sum }_{n = 0}^{MQ - 1} \{ {\sum }_{r = 0}^{R - 1} x ( n + rMQ ) {W}_{MRQ}^{k ( n + rMQ )} \} {W}_{MQ}^{mn} . \qquad ( 8 )$$

The right-hand side of the above formula (8):

$$x ( n + rMQ ) {W}_{MRQ}^{k ( n + rMQ )}$$

corresponds to the phase rotation removal processing, and the following formula:

$${\sum }_{r = 0}^{R - 1}$$

corresponds to synthesis of R sets. Further, the following formula:

$${\sum }_{n = 0}^{MQ - 1} \{ \} {W}_{MQ}^{mn}$$

corresponds to M×Q-point fast Fourier transform. More specifically, the outputs of the FFT circuit 11 having a frequency component number equal to an integral multiple of R plus k is identical to the one obtained by synthesis of R sets after removal of the phase rotation and by M×Q-point fast Fourier transform thereof.

Operation of the frequency component shift circuit 15 will be described with reference to a concrete example. Since R=2 in the case shown in FIG. 4 (M=1, Q=8, R=2), the phase k may assume 0 or 1. In the case of k=0, the frequency component shift circuit 15 may deliver the outputs received from the FFT circuit 11 without modification. In the case of k=1, the input signals having frequency component numbers corresponding to integral multiples of R (=2) minus k (=1), i.e., #15, #7, #3, #11, #1, #9, #5 and #13 are output as the signals of the integral multiples of R, i.e., #0, #8, #4, #12, #2, #10, #6, and #14, respectively. The output signals other than the above frequency numbers may be any output signals because the next-stage weighting multiplier 12 does not use those output signals (due to multiplication by zero).

In the case of FIG. 5 (M=1, Q=4, R=4), the value R=4 allows the phase k to assume any of 0-3. If k=0, the frequency component shift circuit 15 may output the input signal as it is, similarly to the above case. If k=1, the input signals having frequency component numbers corresponding to integral multiples of R (4) minus k (1), i.e., #15, #3, #7 and #11 are output as the outputs of #0, #4, #8, and #12, respectively. If k=2, the input signals having frequency component numbers of #14, #6, #2 and #10 are output as the number of #0, #8, #4, and #12, respectively. If k=3, the input signals having frequency component numbers of #13, #5, #1 and #9 are output as the signals #0, #8, #4, and #12, respectively. In the case of FIG. 5 either, the frequency numbers other than those used in the next-stage weighting calculation unit 12 may be any output signals.

In the present embodiment, fast Fourier transform of input signals is performed in the FFT circuit 11, without conducting the phase rotation removal and chip repetition synthesis. The FFT circuit 11 performs processing of the phase rotation removal and chip repetition synthesis by using a part of the circuit prepared for the processing of the maximum size. Thus, signals obtained by M×Q-point fast Fourier transform can be obtained by performing R-set synthesis of the R set signals with M×Q chips as a set after phase rotation removal thereof, without the need for additionally preparing the phase rotation removal unit and chip repetition synthesis unit. In the present embodiment, the circuit area of the receiving apparatus can be reduced because the phase rotation removal unit and chip repetition synthesis unit are unnecessary. In the present embodiment, similarly to the first embodiment, if Q and R are changed, it is sufficient to change the weighting coefficient of the weighting multiplier 12, which does not complicate the control.

Although the present invention is described as above based on the preferred embodiments thereof, the receiving apparatus and method of the present invention are not limited only to the above exemplified embodiments, and modifications and alterations made from the configurations of the embodiments may fall within the scope of the present invention.

### BRIEF DESCRIPTION OF THE DRAWINGS

FIG. 1 is a block diagram showing the configuration of a receiving apparatus according to a first embodiment of the present invention.

FIG. 2 is a timing chart showing the state of the received signals.

FIG. 3 is a block diagram showing an example of the internal configuration of the FFT circuit.

FIG. 4 is a block diagram showing the state of the input signals for fast Fourier transform where M=1, Q=8, and R=2.

FIG. 5 is a block diagram showing the state of the input signals for fast Fourier transform where M=1, Q=4, and R=4.

FIG. 6 is a block diagram showing the configuration of a receiving apparatus according to a second embodiment of present invention.

FIG. 7 is a timing chart showing the arrangement of the chips during transmission using a chip repetition scheme.

FIG. 8 is a block diagram showing the chip repetition synthesis and the configuration of a frequency domain equalizer in a conventional technique.

FIG. 9 is a block diagram showing an example of the configuration of the phase rotation removal unit.

FIG. 10 is a block diagram showing the configuration of the chip repetition synthesis unit in the conventional technique.

FIG. 11 is a timing chart showing output signals of the control circuit 89 of the chip repetition synthesis unit of FIG. 10.

FIG. 12 is a block diagram showing an example of the configuration of an N-point fast Fourier transform circuit.

FIG. 13 is a block diagram showing an example of an N/2-point fast Fourier transform circuit using part of the N-point fast Fourier transform circuit.

FIG. 14 is a block diagram showing an example of a N/4-point fast Fourier transform circuit using part of the N-point fast Fourier transform circuit.

FIG. 15 is a block diagram showing an example of the configuration of a weighting multiplier.

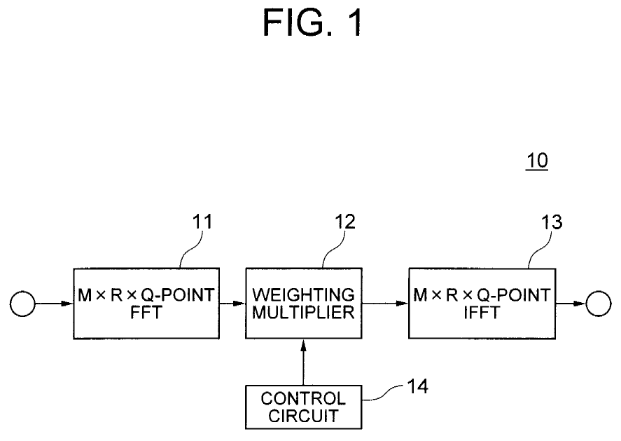

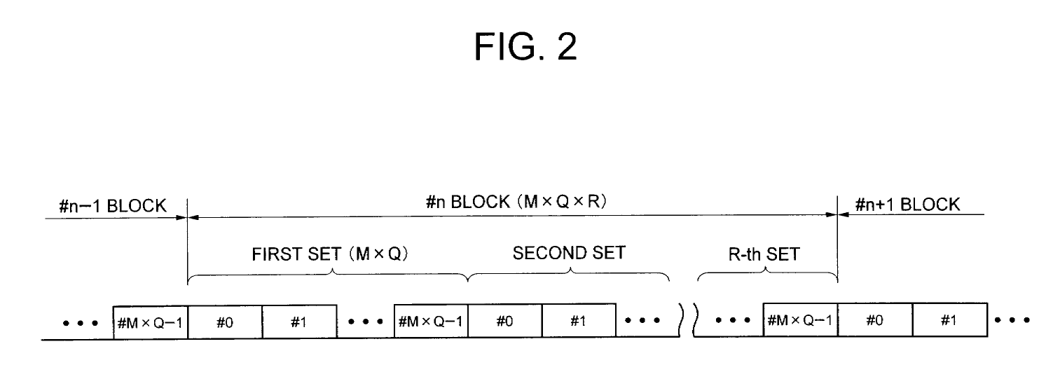

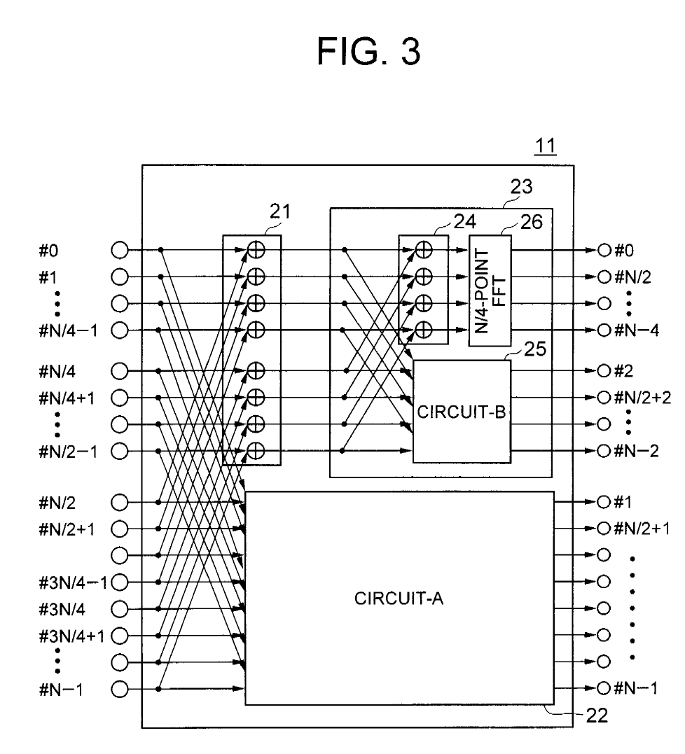

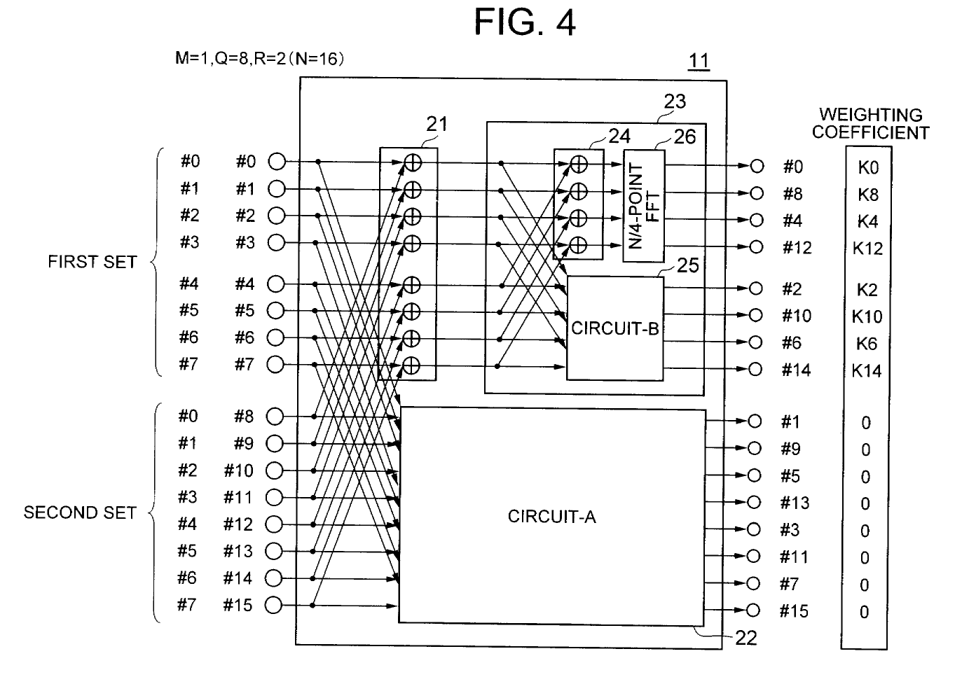

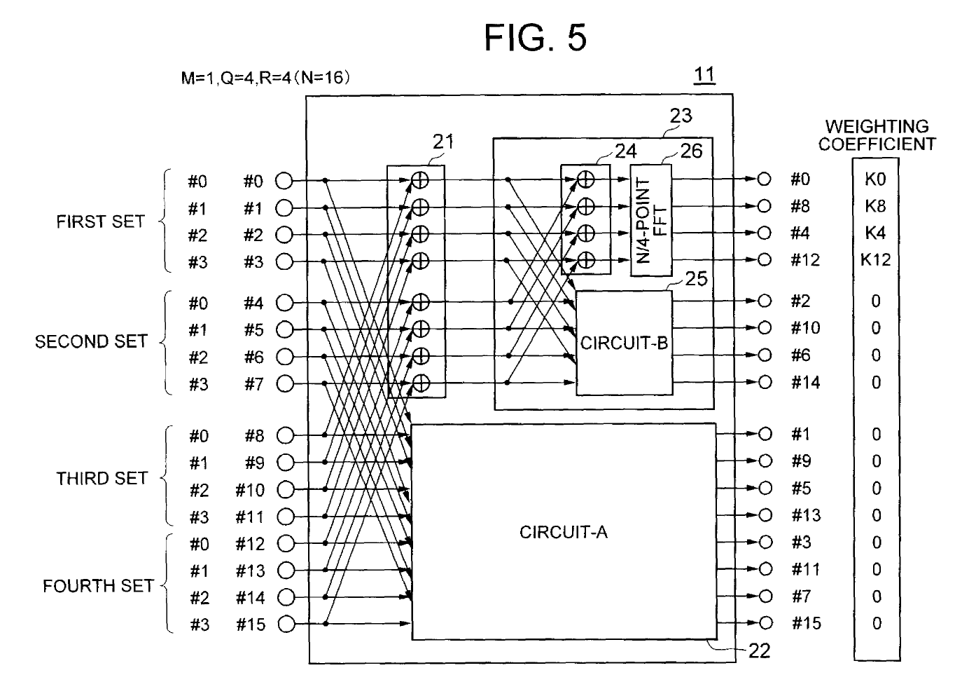

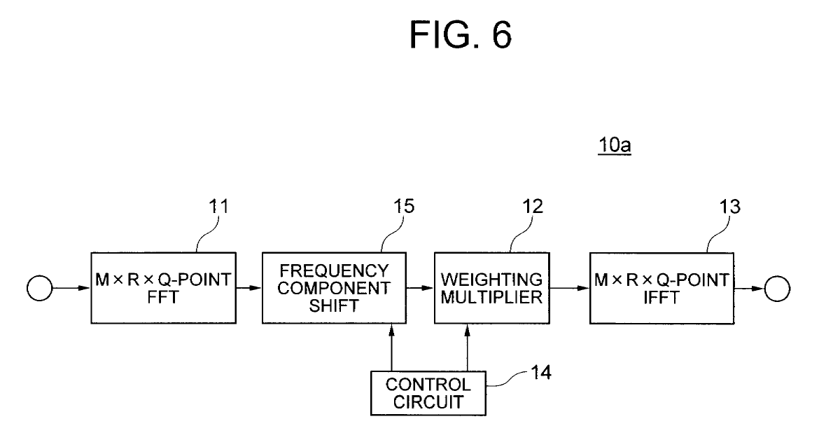

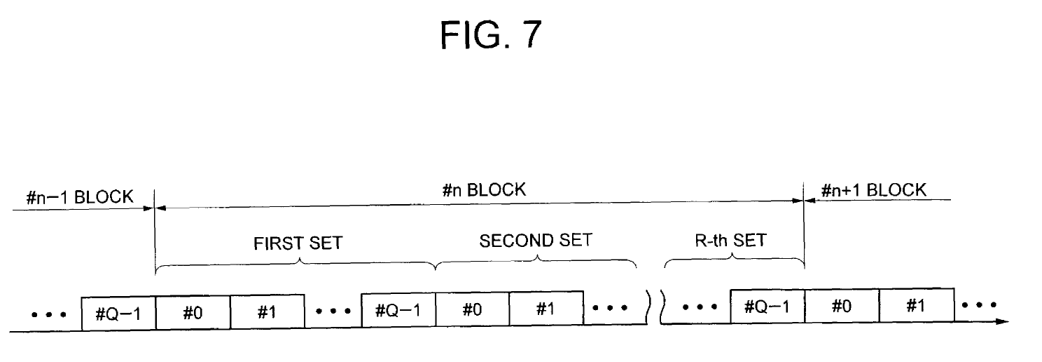

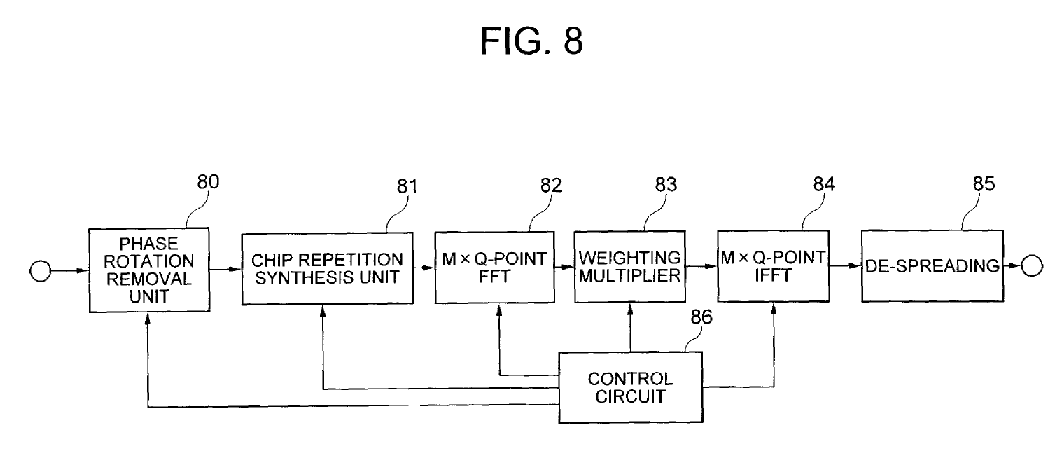

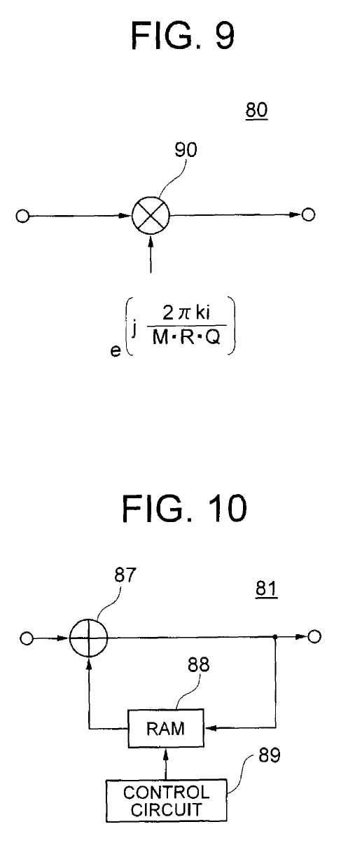

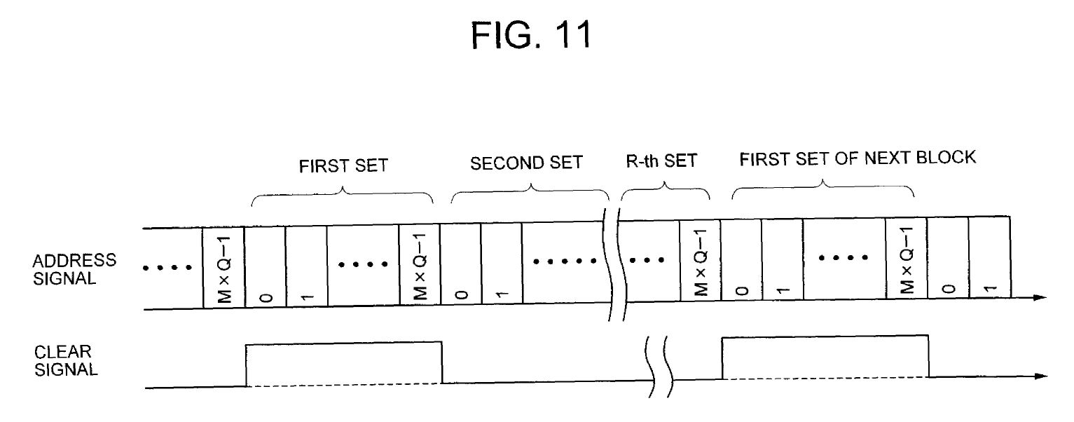

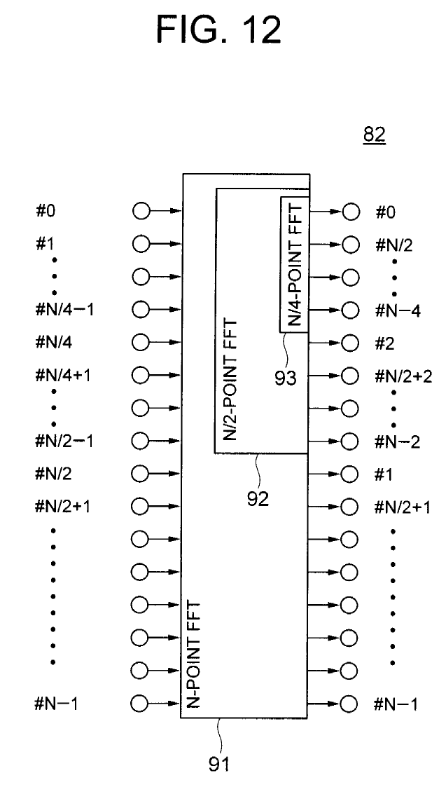

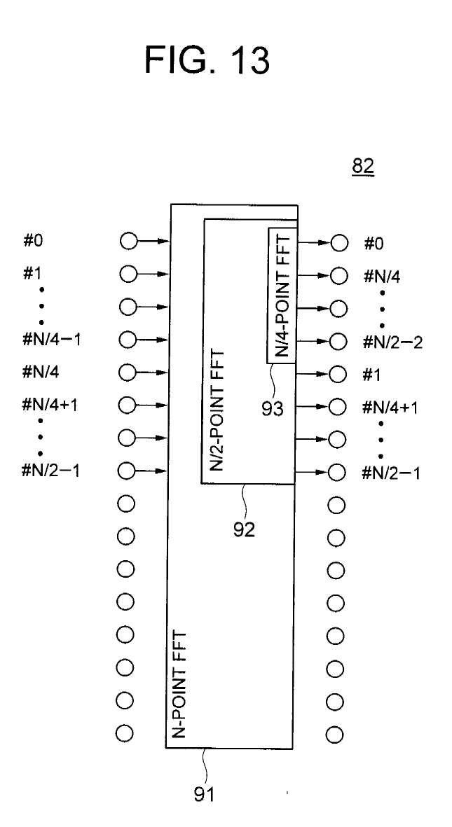

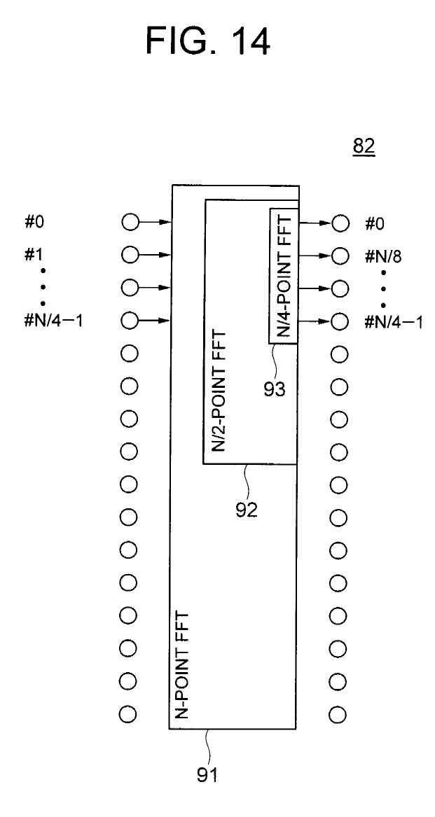

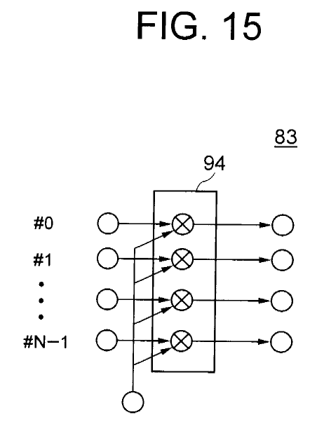

1-12. (canceled)

13. A receiving apparatus of a code division multiple access system using a chip repetition scheme repetitively transmitting a spreading chip sequence for R times (R: power-of-two) with Q chips as a set (Q: power-of-two), said receiving apparatus comprising:
a fast Fourier transform circuit performing M×R×Q-point fast Fourier transform of received signals to decompose said received signals into complex amplitudes of M×R×Q frequency components and output the same, where M (power-of-two) is an over-sampling rate of said received signals;
a weighting multiplication circuit multiplying, by a weighting coefficient for propagation channel equalization, a frequency component having a frequency component number equal to an integral multiple of R among said M×R×Q frequency components obtained by said fast Fourier transform circuit; and
an inverse fast Fourier transform circuit performing inverse fast Fourier transform using a frequency component output from said weighting multiplier and having the frequency component number equal to the integral multiple of R.

14. The receiving apparatus according to claim 13, further comprising a frequency component shift circuit shifting M×R×Q frequency components output from said fast Fourier transform circuit by a specified component number, to input the same to said weighting multiplier.

15. The receiving apparatus according to claim 14, wherein said frequency component shift circuit delivers to said weighting multiplier a frequency component having a frequency component number equal to the integral multiple of R minus k as a frequency component having a frequency component number equal to the integral multiple of R.

16. The receiving apparatus according to claim 13, wherein said weighting multiplier multiples a frequency component having a frequency component number other than the integral multiple of R among said M×R×Q frequency components by a weighting coefficient of zero.

17. The receiving apparatus according to claim 13, wherein said fast Fourier transform circuit nulls an output of a frequency component having a frequency component number other than the integral multiple of R among said M×R×Q frequency components.

18. The receiving apparatus according to claim 14, wherein said inverse fast Fourier transform circuit performs M×R×Q-point inverse fast Fourier transform.

19. A receiving method of a code division multiple access system using a chip repetition scheme repetitively transmitting a spreading chip sequence for R times (R: power-of-two) with Q chips as a set (Q: power-of-two), said method comprising:
performing M×R×Q-point fast Fourier transform of received signals to decompose said received signals into complex amplitudes of M×R×Q frequency components and outputting the same, where M (power-of-two) is an over-sampling rate of said received signals;
multiplying, by a weighting coefficient for propagation channel equalization, a frequency component having a frequency component number equal to an integral multiple of R among said M×R×Q frequency components obtained by said fast Fourier transform; and
performing inverse fast Fourier transform using said frequency component multiplied by said weighting coefficient and having the frequency component number equal to the integral multiple of R.

20. The receiving method according to claim 19, wherein said multiplying said weighting coefficient shifts M×R×Q frequency components output from said fast Fourier transform by a specified component number, and multiplies said shifted frequency component having the frequency component number equal to the integral multiple of R by said weighting coefficient.

21. The receiving method according to claim 20, wherein said shifting said frequency component shifts said frequency components so that a frequency component number equal to the integral multiple of R minus k shifts to the frequency component number equal to the integral multiple of R.

22. The receiving method according to claim 19, wherein said multiplying by said weighting coefficient multiples a frequency component having a frequency component number other than the integral multiple of R among M×R×Q frequency components by a weighting coefficient of zero.

23. The receiving method according to claim 19, wherein said fast Fourier transform nulls an output of frequency component having a frequency component number other than the integral multiple of R among M×R×Q frequency components.

24. The receiving method according to claim 19, wherein said inverse fast Fourier transform performs M×R×Q-point inverse fast Fourier transform.
